(19) United States
(12) Patent Application Publication
(10) Pub. No.: US 2006/0055747 A1
(43) Pub. Date: Mar. 16, 2006

(54) Method and apparatus for forming and charging fluid droplets

(76) Inventor: Thomas W. Steiner, Burnaby (CA)

Correspondence Address: Mark G. Bocchetti;Patent Legal Staff, Eastman Kodak Company, 343 State Street, Rochester, NY, 14650-2201, US

(21) Appl. No.: 11/225,346

(22) Filed: Sep. 13, 2005

Related U.S. Application Data
(60) Provisional application No. 60/609,248, filed on Sep. 14, 2004.

(51) Int. Cl. B41J 2/105

(52) U.S. Cl. 347/82

(57) ABSTRACT

A continuous inkjet recording apparatus forms a continuous stream of droplets from a jetted fluid. A charge electrode is employed to characterize droplets selected for printing from droplets that are not selected for printing. The charge electrode is sized and optionally positioned such that a specific droplet scheme can be employed to minimize droplet trajectory variations from droplet-to-droplet electrostatic field effects. Additionally, the charging surface is sized and positioned to minimize droplet trajectory variations that arise from charge electrode-to-droplet electrostatic field effects. By minimizing both these sources of droplet trajectory variation, the final print quality of the continuous inkjet apparatus is improved.

### CROSS REFERENCE TO RELATED APPLICATIONS

This is a 111A application of Provisional Application Ser. No. 60/609,248, filed Sep. 14, 2004.

### FIELD OF THE INVENTION

The invention pertains to the field of ink jetting fluid droplets and, in particular, to a method and apparatus for minimizing trajectory deviations of a droplet in flight during a charging of a newly formed droplet.

### BACKGROUND OF THE INVENTION

The use of ink jet printers for printing information on a recording media is well established. Printers employed for this purpose may be grouped into those that emit a continuous stream of fluid droplets, and those that emit droplets only when corresponding information is to be printed. The former group is generally known as continuous inkjet printers and the latter as drop-on-demand inkjet printers. The general principles of operation of both of these groups of printers are very well recorded. Drop-on-demand inkjet printers have become the predominant type of printer for use in home computing systems, while continuous inkjet systems find major application in industrial and professional environments. Typically, continuous inkjet systems are faster than drop-on-demand printers and produce higher quality printed images.

Continuous inkjet printers typically include a print head that incorporates a fluid supply system and a nozzle plate with one or more fluid nozzles fed by the fluid supply. A gutter assembly is positioned downstream from the nozzle plate in the flight path of fluid droplets to be guttered. The gutter assembly catches fluid droplets that are not needed for printing on the recording medium.

In order to create the fluid droplets, a droplet generation means is associated with the print head. The droplet generation means stimulates (by a variety of mechanisms discussed in the art) the fluid stream within and just beyond the print head. This is done at a frequency that forces the streams of fluid, which were initially jetted from the nozzles, to be broken up into a continuous series of fluid droplets at a break-off point within the vicinity of the nozzle plate.

In the simplest case, this stimulation is carried out at a fixed frequency that is determined to be optimal for the particular fluid and matching the natural resonance frequency of the fluid jet ejected from the nozzle. The spacing of the droplets is related to the jet velocity v, and the stimulation frequency f, by the relationship: v=f S. In U.S. Pat. No. 3,596,275, Sweet discloses such a continuous inkjet recorder. Central to this invention is the generation of droplets at a fixed frequency and with a constant velocity and mass. Sweet discloses three methods to do this. The first technique involves vibrating the nozzle itself. The second technique excites a fluid column electrohydrodynamically (EHD) with an EHD exciter. The third technique imposes a pressure variation on a fluid in the nozzle by means of a piezoelectric transducer typically placed within the cavity feeding the nozzle.

Arrangements for selecting printing droplets from non-printing droplets from the continuous stream of ink droplets have been well described in the art. One commonly used practice is that of electrostatic charging and electrostatic deflecting selected droplets as described in U.S. Pat. No. 1,941,001 to Hansell and U.S. Pat. No. 3,373,437 to Sweet et al. In these patents, a charge electrode is positioned along the flight path of the ink droplets. The function of the charge electrode is to selectively charge the fluid droplets as the droplets break off from the jet. This is typically possible because the jetted fluid has conductive properties. One or more electrostatic deflection electrodes positioned downstream from the charge electrodes deflect a charged fluid droplet either into the gutter or onto the recording media. For example, droplets that are to be guttered are charged and consequently deflected into the gutter assembly, while droplets that are selected to print on the media are not charged and continue un-deflected towards the recording surface. In some systems, this arrangement is reversed, and the uncharged droplets are guttered, while the charged ones are ultimately printed with. Electrostatic systems are advantageous in that they permit large droplet deflections.

In inkjet systems where such electrostatic charging is required, various forms of charging electrodes have been described in the prior art for charging droplets as they break off from a fluid stream. Charge electrodes are manufactured in a variety of shapes including annular structures that completely enclose the fluid jet near droplet break-off, or structures that partially enclose the fluid jet such as U or V-shaped electrodes.

Planar charge electrodes are another example of charging electrode systems. Typically, planar charging electrodes are made to lie alongside the jet for some distance. The electrodes need some length along the jet to allow for a suitable level of capacitive coupling to the fluid stream to ensure adequate charging of droplets, and to provide a partial shielding effect, to reduce the influence of other external fields on the fluid charge in the region of droplet break-off. In some instances the charge electrodes are also used to deflect the jet or droplets, with or without the assistance of a deflection electrode system located at a point further downstream along the path of the droplets.

The very high speed printing performance requirements of current state of the art continuous inkjet recording systems typically require small, closely spaced drops. In this situation, it may be very likely that the charging of a specific droplet will be adversely affected by an electric field established due to the presence of any transferred charge to any of the preceding droplets. Additional electric fields may prevent the specific droplet from being charged with the correct charge level and may lead to a multitude of printhead problems. In the case where charged droplets are deflected to print on a recording surface, droplet charge variability may lead to placement errors and poor quality printing may result. In the case where charged droplets are guttered, droplet charge variability may lead to ink contamination of the deflection plate and/or gutter as the droplets are deflected incorrectly.

Several approaches have been noted in the prior art to reduce charge distortions resulting from the electric fields of preceding droplets. In U.S. Pat. No. 3,562,757, Bischoff describes how the use of a number of guard droplets between successive charged droplets act as a shield to minimize the adverse effects that an electric field of one charged droplet has on the subsequent formation of another charged droplet. Additionally, Bischoff states that the guard drop scheme improves the aerodynamics of the droplet trajectories. Specifically, Bischoff explains that every emitted droplet leaves in its wake a region of turbulence that causes variability in the required trajectory of a following droplet that enters the region of turbulence. When guard droplets are employed, they are subsequently separated from the droplets to be printed by the charge deflection electrodes. When the guard droplets are separated, the spacing between the remaining droplets (which may be printed with) is increased, and therefore the effects of turbulence are effectively reduced or substantially eliminated.

In U.S. Pat. No. 4,633,268, Miroku describes how a set of parallel charge electrodes having a parallel spacing, d, expressed by the relationship d=0.77 S (S being the droplet-to-droplet spacing) may minimize the electrical effects on a jet column created by a charge of a preceding ink droplet on the basis of the resultant electric field from the charge of the preceding ink droplet and the virtual charge of the electrical image thereof.

In U.S. Pat. No. 4,032,924, Takano et al. describe a charge control system, wherein the amount of charge applied to a printing ink droplet is corrected and calculated in accordance with a total of the field strength of the electric fields due to the charge amplitude of the preceding ink droplets.

Thus, the prior art has dealt primarily with the solving droplet-to-droplet charge interaction problems associated with electric field effects imposed upon a given droplet by preceding emitted droplets. These droplet-to-droplet interaction problems can affect the proper charging of a given droplet and consequently, adversely affect the desired trajectory of that droplet.

However, similar deflection problems can also arise from the effect of the charge electrode itself, especially if the charge electrode is relatively long in the jetted fluid direction. A problem associated with a relatively long charge electrode is that the changing voltage state on the electrode will affect the trajectory of previously emitted droplets in flight along its length in a print data-dependent manner. Specifically, the long charge electrode itself can cause undesired deflections in previously emitted droplets during the charging cycle of a succeeding droplet. This variation in droplet deflection based on a print data state can lead to print data dependent droplet positioning on the recording medium and poorer quality printing.

Thus, there is a need for a method and apparatus that reduces undesired droplet trajectory variations resulting from droplet-to-droplet electric field interactions as well as charge electrode-to-droplet electric field interactions created by a charge electrode.

The foregoing examples of the related art and limitations related thereto are intended to be illustrative and not exclusive. Other limitations of the related art will become apparent to those of skill in the art upon a reading of the specification and a study of the drawings.

### SUMMARY OF THE INVENTION

A continuous inkjet recording system emits a one or more continuous streams of droplets formed from a corresponding one or more fluid jets. One or more systems controllers may be used to select specific droplets within each of the streams of droplets. Selected droplets may include non-print selectable droplets that will not be printed with and print selectable droplets that may be printed with if so required by a print data stream. Non-print selectable droplets may be employed in a guard drop scheme to minimize the undesired droplet-to-droplet field effects. Specific print selectable droplets selected for printing may be charged by a charge electrode to become corresponding print selectable droplets. A charge electrode is used to characterize print selected droplets from other droplets in accordance with a given charging scheme. Electrostatic deflection electrodes may be used to separate the print selected droplets from the other droplets based on this charge characterization. The separated print selected droplets may be applied onto a recording media whereas the remaining droplets may be captured by a guttering means.

Print quality is typically dependant upon a placement error of the print selected droplets. Variations in the trajectory of the print selected droplets are typically detrimental to achieving high print quality. Undesired electrostatic influences that arise form a charging scheme employed to characterize droplets may adversely affect the desired trajectory of print selected droplets. A charge electrode that has a long charging surface may adversely affect the trajectory of previously emitted print selected droplet during the charging of a subsequently formed print selected droplet. A long charging surface may adversely deflect an upstream region of the jetted fluid from which a corresponding print selectable droplet is formed creating trajectory variations even before the droplet is actually formed. Both these adverse charge electrode-to-droplet effects may occur in a random fashion since they are dependant upon the charging of print selectable droplets in accordance with a print data stream.

The present invention employs methods and apparatus for forming and selectively charging droplets within a continuous stream of fluid droplets to reduce charge electrode-to-droplet field effects. The present invention may accommodate a specific guard scheme to minimize the undesired droplet-to-droplet field effects while at the same time minimizing the undesired charge electrode-to-droplet field effects.

A first aspect of the present invention provides a method for forming and charging fluid droplets. The method includes forming a stream of the fluid droplets. At least two successively formed fluid droplets within the continuous stream are separated from each other by a distance S. Distance S is proportional to charging length L_{CE} of a charge electrode which is used to deliver an electrical charge to the fluid droplets. The method may also include selecting and forming two successive print selectable droplets within the continuous stream. In another aspect of the invention, the two successive print selectable droplets formed within the stream of fluid droplets are separated from each other by an integer number N of non-print selectable droplets. The integer number N is at least one and is proportional to the charging length L_{CE}. Distance S may be determined by a 1:X guard drop scheme. Integer number N may be determined by a 1:X guard drop scheme.

The method may include determining distance S and integer number N to satisfy a relationship: L_{CE}≦2S(N+1). The method may include forming the stream of fluid droplets at a break-off point of a fluid jet. The method may include positioning the charge electrode such that a first portion of the charge electrode extends in a direction downstream from a fluid droplet formed at the break-off point. A length L_{CEB} of the first portion of the charge electrode may satisfy a relationship: L_{CEB}≦S(N+1). The length L_{CEB} of the first portion of the charge electrode may be substantially one half of the charging length L_{CE}.

In another aspect of the invention, the method may include positioning the charge electrode such that a substantially uniform and constant force is exerted on a portion of the fluid jet during a charging of a print selectable droplet formed at the break-off point. The charge electrode may be positioned such that a second portion of the charge electrode extends in a direction upstream from a droplet formed at the break-off point. A length L_{CEB ′} of the second portion of the charge electrode may satisfy a relationship: L_{CEB′}≦S(N+1). A length L_{CEB′} of the second portion of the charge electrode may be determined to be equal to a length L_{CEB} of the first portion of the charge electrode.

Yet another aspect of the invention provides for an apparatus for modifying a fluid jet. The apparatus includes a droplet generation circuit having an electrically controlled transducer adapted to perturb the fluid jet to form a stream of fluid droplets. The apparatus also includes a charge electrode having a length L_{CE}, said charge electrode being capable of delivering an electrical field to charge selected droplets when a potential is applied to the charge electrode wherein said droplet generation circuit perturbs the jet of fluid in a manner that causes the jet of fluid to form a stream of successive droplets each droplet being separated by a distance S that is proportional to length L_{CE} of the charge electrode.

The apparatus can include a droplet generation circuit adapted to form a stream of fluid droplets with successive print selectable droplets separated from each other by at least one non-print selectable droplet. Wherein the charging length L_{CE} is further proportional to the number N of non-print selectable droplets between print selectable droplets. In other aspects of the invention, the apparatus further comprises at least one system controller that may be operable to cause a pattern of electrical potential to be applied to the charge electrode in a manner that causes a charge to be delivered to selected ones of the stream of fluid droplets in accordance with a print data stream. The system controller may be operable for selecting the two successive print selectable droplets and the non-print selectable droplets in accordance with a 1:X guard drop scheme. The charging length L_{CE}, distance S and number N of non-print selectable drops between print selectable drops may be determined from a relationship: L_{CE}≦2S(N+1).

The droplet generation circuit may be operable for forming the least one stream of fluid droplets at a break-off point of a corresponding at least one fluid jet wherein a first portion of the charging surface extends downstream from a droplet formed at the break-off point. A length L_{CEB} of the first portion may be determined from a relationship: L_{CEB}≦S(N+1). A length L_{CEB} of the first portion may be substantially one half of the charging length L_{CE}. In other aspects of the invention, the droplet generation circuit is operable for forming the stream of fluid droplets and wherein a second portion of the charge electrode extends in a direction upstream from a droplet formed at the break-off point. A length L_{CEB′} of the second portion may be determined from a relationship: L_{CEB′}≦S(N+1).

The apparatus further comprising at least one electrostatic deflection electrode positioned downstream of the charge electrode and adapted to receive an electrical deflection signal and to generate and electrostatic field for altering trajectory of at least one of a non-print selectable droplet, a print selectable droplet selected not to be a print selected droplet, and a print selectable droplet selected to be a print selected droplet. The apparatus may be a continuous inkjet printing apparatus, or a multi jet continuous inkjet printing apparatus.

In addition to the exemplary aspects and embodiments described above, further aspects and embodiments will become apparent by reference to the drawings and by study of the following detailed descriptions.

### BRIEF DESCRIPTION OF THE DRAWINGS

FIG. 1A shows a schematic representation of a prior art charge electrode including a print data dependant effect on droplets within a continuous stream of droplets;

FIG. 1B shows a schematic representation of another prior art charge electrode including a print data dependant effect on droplets within a continuous stream of droplets;

FIG. 1C shows the schematic representation of the prior art charge electrode of FIG. 1a including another print data dependant effect on droplets within a continuous stream of droplets;

FIG. 2 shows an embodiment of a printing apparatus; and

FIGS. 3A-3E shows a sequence of schematic representations of a charge electrode as per one embodiment of the present invention including the effect that the charge electrode has on a trajectory of droplets within a continuous stream of droplets.

### DETAILED DESCRIPTION OF THE INVENTION

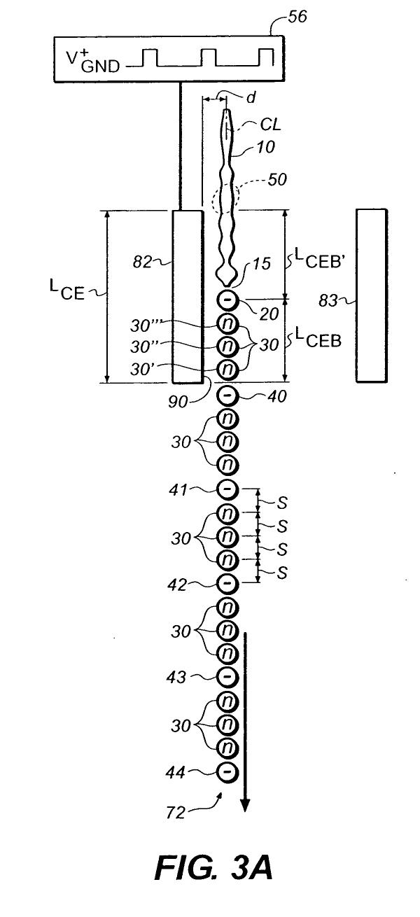

FIG. 2 shows a printing apparatus 22 having one embodiment of the apparatus 14 of the present invention. Printing apparatus 22 comprises a housing 24 that can comprise any of a box, closed frame, continuous surface or any other enclosure defining an interior chamber 26. In the embodiment of FIG. 2, interior chamber 26 of housing 24 holds an inkjet printhead 34, a translation unit 36 that positions a receiver surface 37 relative to inkjet printhead 34 and system controller 38. System controller 38 can comprise a micro-computer, micro-processor, micro-controller or any other known arrangement of electrical, electromechanical and electro-optical circuits and systems that can reliably transmit signals to inkjet printhead 34 and translation unit 36 to allow the pattern-wise disposition of donor fluid 39 onto receiver surface 37. System controller 38 can comprise a single controller or it can comprise a plurality of controllers.

As is illustrated in FIG. 2, inkjet printhead 34 comprises a source of pressurized donor fluid 52 such as a pressurized reservoir or a pump arrangement and a nozzle 54 allowing the pressurized donor fluid 39 to form a fluid jet 10 traveling in a first direction 58 toward receiver surface 37. A droplet generation circuit 64 has a transducer 62 which applies a force to the fluid jet perturbing fluid jet 10 to form a stream of droplets 72 at a break-off point 15. Transducer 62 can apply such a perturbing force in a variety of ways all known to those of skill in the art, including by way of example and not by way of limitation, introducing waveforms into the donor fluid jet, deflecting fluid jet 10 and/or selectively heating a portion of fluid jet 10. Transducer 62 can include, but is not limited to an electromagnetic or electro-mechanical apparatus for inducing a vibration in the flow, which can be done, for example, by way of electrohydrodynamic (EHD) stimulation, piezoelectric stimulation or thermal stimulation to fluid jet 10.

Transducer 62 applies a force to fluid jet 10 in response to a droplet formation electrical signal 66. Discrete or integrated components within the droplet generation circuit 64 such as timing circuits of a type well known to those of skill in the art can be used or adapted for use in generating the droplet formation electrical signal 66 to form droplets in the manner described herein.

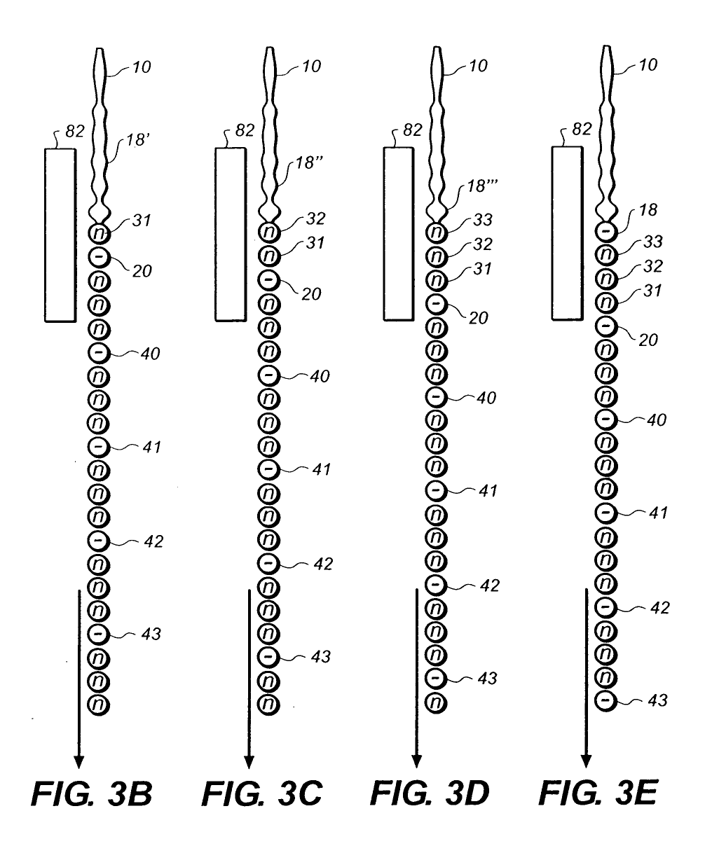

In the example illustrated in FIGS. 2 and 3A-3E, two types of droplets are formed, print selectable droplets 20 suitable in size and composition for forming a desired pattern on receiver surface 37 and non-print selectable droplets 30 suitable in size and composition for other uses as described herein. The print selectable droplets 20, may be charged by a charge electrode 82 to become corresponding print selectable droplets 40, 41,42, 43 and 44 in accordance with a given charging scheme.

An electrostatic deflection electrode 84 is used to apply a charge to the stream of droplets separate the print selected droplets from the other droplets based on this charge characterization. Optionally, an additional electrostatic deflection electrode 86 can be used to apply additional electrostatic force to deflect print selectable droplets 40, 41, 42, 43, and 44. Print selectable droplets 40, 41, 42, 43, and 44 are guided by such electrostatic forces onto receiver surface 37 while the remaining droplets travel to a gutter 88.

In the embodiment illustrated in FIGS. 3A-3E to follow an apparatus and method will be described for use in guiding donor fluid 39 in inkjet printhead 34. This is done for convenience and it will be understood that donor fluid 39 is not limited thereby to an ink and can comprise any fluid that can be imparted with an electrical charge and that can form a jet and droplets as described herein. Typically, donor fluid 39 will carry a colorant, ink, dye, or other image forming material. However, donor fluid 39 can also carry electrically conductive material, dielectric material, electrically insulating material, magnetic material, magnetizeable material, optically conductive material or other functional material.

Further, in the embodiment illustrated in FIGS. 2 and 3A-3E, receiver surface 37 is shown as comprising a generally paper type receiver medium, however, the invention is not so limited and receiver surface 37 can comprise any number of shapes and forms and can be made of any type of material upon which a pattern of donor fluid 39 can be imparted in a coherent manner.

Accordingly, in the embodiment illustrated in FIG. 2, translation unit 36 has been shown as having a motor 28 and arrangement of rollers 29 that selectively positions a paper type receiver surface 37 relative to a stationary inkjet printhead 34. This too is done for convenience and it will be appreciated, that receiver surface 37 can comprise any type of receiver surface 37 and translation unit 36 will be adapted to position either one of the receiver surface 37 and inkjet printhead 34 relative to each other.

FIGS. 3A-3E show a schematic representation of successive sequences of a stream of droplets 72 charged by one embodiment of an apparatus 14 of the present invention. In the embodiment of FIGS. 3A-3E, stream of regularly spaced fluid droplets 72 is generated by forming a fluid jet 10 and causing droplets 72 to periodically separate from fluid jet 10 at a break-off point 15 adjacent to a charge electrode 82.

As is also shown in FIGS. 3A-3E, droplet generation circuit 64 causes the continuous stream of droplets 72 to form having a center-to-center separation distance S between the regularly spaced droplets that is equal to a characteristic wavelength W, determined by the stimulation frequency of the droplet formation electrical signal 66 and the droplet velocity of donor fluid 39 in fluid jet 10. A center-line CL of fluid jet 10 is separated from charging surface 90 of a planar type charge electrode 82 by a distance d, as shown in FIG. 3A. Typically, the center point of each of the resulting un-deflected droplets of stream of droplets 72 is also substantially separated from charging surface 90 of a planar type charge electrode 82 by distance d.

Although charge electrode 82 is shown as a single planar charge electrode, other charge electrode embodiments are not precluded from the scope of the present invention. Other such embodiments of charge electrodes may include, but are not limited to, V-shaped electrodes that may be formed by two planar electrodes, or “tunnel” electrodes that can be made from planar segments or from a cylindrical tube. Additionally, one or more optional additional charge electrodes 83 may be employed in conjunction with charge electrode 82 as shown in FIG. 3A. Additional charge electrode 83 can be positioned in a substantially parallel orientation with charge electrode 82, and fluid jet 10 is preferably centered between the two electrodes. Although additional charge electrode 83 may not be necessary with respect to the charging operation, improved shielding may likely occur. The trajectories of each of the formed and charged droplets in FIGS. 3A-3E may be subsequently selectively deflected by electrostatic deflection electrode 84 and one or more optional additional deflection electrodes 86 on the basis of the specific charging scheme used to distinguish and separate droplets selected to be printed from droplets selected not to be printed.

In the embodiment illustrated in FIGS. 3A-3E, a guard drop scheme is used. In a guard drop scheme, non-print selectable droplets 30 are provided between print selectable droplets 20, 40, 41, 42, 43 and 44 as guard droplets. These guard droplets may help minimize undesired droplet-to-droplet charging interaction of droplets that are selected for printing. A guard drop scheme typically defines a relationship between a sequence of print selectable droplets 20 and a sequence of non-print selectable droplets 30. The term “print selectable droplets” is herein used to describe specific droplets 20 selected from a sequence of droplets, the print selectable droplets being available for printing. Print selectable droplets 20, 40, 41, 42, 43 and 44 may be printed or not printed as required by a print data stream. The term “print selected droplets” is herein used to describe specific ones of the print selectable droplets e.g. droplets 20, 40, 41, 42, 43, and 44, that are selected for printing based on data in a print data stream that contains data characterizing a pattern of donor fluid 39 to be applied to receiver surface 37 and which have been given or otherwise have the correct charge state for printing. The term “non-print selectable droplets” is herein used to describe droplets 30 that are not available for printing but form guard droplets between successive print selectable droplets so as to minimize unwanted droplet-to-droplet field effects between the print selectable droplets 20, 40, 41, 42, 43 and 44. Non-print selectable droplets 30 may be used in a guard drop scheme to minimize unwanted droplet-to-droplet field effects between the print selectable droplets within a given stream of droplets, or between droplets in adjacent streams.

During printing, system controller 38 receives a print data stream and determines therefrom which specific droplets within a continuous stream of droplets are to be selected for printing. The print data stream can comprise computer code, instructions and/or print data transmitted to the processor from an data source. A print data stream will have data that varies in accordance with the content and placement requirements of the specific pattern to be printed on receiver surface 37. System controller 38 causes a charge electrode potential signal 56 to be applied at charge electrode 82.

Under the influence of charge electrode potential signal 56 applied to charge electrode, charges may be delivered to any print selectable droplet 20, as shown in FIG. 3A. These charges may be applied in accordance with the intended status of a droplet formed at break-off point 15 as a print selected, non-print selected or non-print selectable droplet determined in accordance with information in the print data stream. If the print data stream indicates that a specific print selectable droplet 20 is to be used for printing, charge electrode potential signal 56 will be arranged so that print selectable droplet 20, 40, 41, 42, 43 and 44 will be charged and become a print selected print selectable droplet (e.g. 40, 41, 42, 43, 44). If the print data stream indicates that a specific print selectable droplet is not to be used for printing, then that print selectable droplet may be charged as a non-print selectable droplet. A print selectable droplet charge and a non-print selectable droplet charge may have the same polarity, opposite polarity, or one or the other may have a nominally neutral charge. Additionally, varying levels of these charges may be applied if required by the scheme used to separate droplets selected for printing from droplets not selected for printing.

In the preferred embodiment of the present invention shown in FIGS. 3A-3E, a 1 in 4 (1:4) guard drop scheme is employed. In FIG. 3A, groups of three non-print selectable droplets 30 separate each pair of successive print selectable droplets 20. Print selectable droplets 20 may in turn, be selectively charged as print selected droplets indicated by the print data stream. In this preferred embodiment of the present invention, print selectable droplets that are selected to be print selectable droplets 40,41,42, 43, 44 are charged with a substantially negative polarity. A positive charge electrode potential signal 56 that acts upon fluid jet 10 may induce such a negative polarity. Fluid jet 10 preferably has substantially conductive properties. In this embodiment, charge electrode potential signal 56 includes a potential waveform in accordance to the guard drop scheme and a print data stream. Charge electrode potential signal 56 has a potential waveform including amplitude and duration components suitable for the appropriate charging of non-print selectable droplets, and for the appropriate charging of print selectable droplets 20 selected to be, or not to be, print selected droplets. In this preferred embodiment of the invention, print selectable droplets that are selected not to be print selected droplets (i.e. non-print selected droplets) are charged with a substantially neutral polarity induced by setting the charge electrode potential close to zero. The potential setting on the charge electrode may not be exactly zero, but some value near zero. This may be done to compensate for other fields in the vicinity of the print selectable droplet to produce a desired substantially zero charge on the droplet. In this preferred embodiment of the present invention, non-print selectable droplets 30 are charged substantially with a substantially neutral polarity. In this preferred embodiment of the invention, the negatively charged print selected droplets (i.e. negatively charged print selectable droplets 20, 40, etc) may be deflected onto a recording media by electrostatic deflection electrode 84 and/or optional additional deflection electrode 86.

Without limitation, other preferred embodiments of the invention may use alternate charging schemes to charge print selectable droplets selected to be print selected droplets, print selectable droplets selected not to be print selected droplets and non-print selectable droplets. These charging schemes may also include charging a print selectable droplet 20 that has been selected to be a print selectable droplet 40 with a substantially neutral charge. Other embodiments of the present invention may charge a print selectable droplet 20 selected to be a print selected droplet 40 with a charge that is opposite in polarity to a charge induced on a print selectable droplet selected not to be a print selected droplet.

Further embodiments of the present invention may charge a print selectable droplet 20 selected to be a print selectable droplet 40 with a charge that has the same polarity as the charge of a print selectable droplet 20 selected not to be a print selected droplet, but in which the magnitude of the charges of each of the respective two types of droplets substantially differs. Embodiments of the present invention are applicable for any suitable charging scheme that may be employed to distinguish whether a specific print selectable droplet is used for printing or not. Non-printing droplets typically include print selectable droplets not selected for printing and non-print selectable droplets (i.e. guard droplets). A print selectable droplet that is not selected for printing may not be charged in an identical fashion as a non-print selectable droplet. Identical charging of all droplets that are not printed will typically allow a single guttering means to be used to collect all the “non-printing” droplets. If desired, additional guttering means may be employed with different charging and deflection schemes to collect the different types of these “non-printing” droplets. Such a system would typically be more complex and costly.

Referring back to the preferred embodiment of the present invention shown in the sequence of FIGS.2A-2E, droplets 20, 40, 41, 42, 43 and 44 are print selectable droplets that are separated from each other by groups of three non-print selectable droplets 30. In this preferred embodiment of the invention, print selectable droplet 20 is selected to be a print selected droplet by a print data stream. Consequently, as illustrated in FIG. 2A, charge electrode 82 potentials are driven to positive voltage to induce a substantially negative charge on print selectable droplet 20. Charge electrode 82 potentials were driven to near neutral to induce substantially neutral charges on the group of three preceding non-print selectable droplets 30 that were formed immediately prior to the formation of print selectable droplet 20. In FIGS. 2A-2E, all print selectable droplets 20, 40, 41, 42, 43 and 44 were selected to be print selected droplets and thus have a substantially negative polarity, though it is to be understood that the final charge state of each respective print selectable droplet depends on the print data stream. In the instance where a specific print selectable droplet is not intended to print according to the print data stream, it will be charged with a neutral polarity and be guttered as in the case of the non-print selectable droplets.

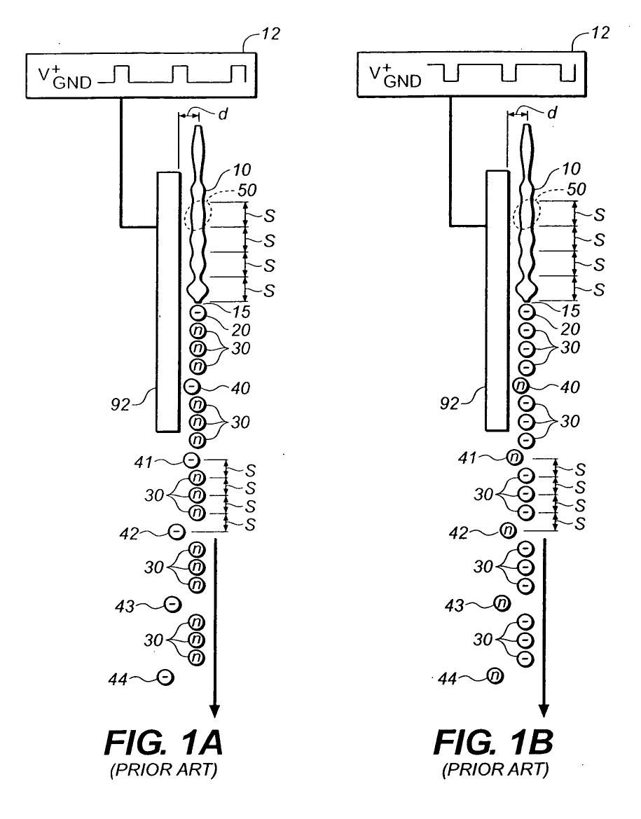

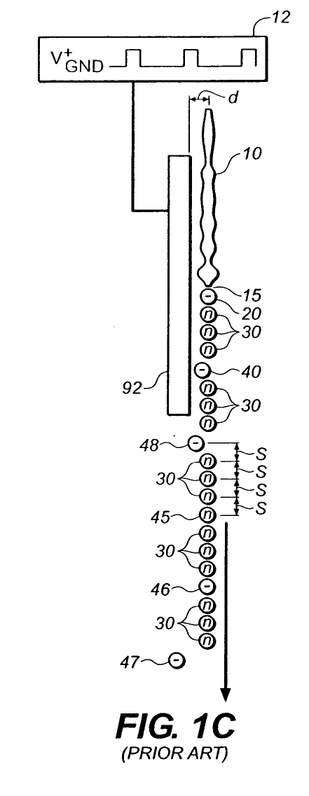

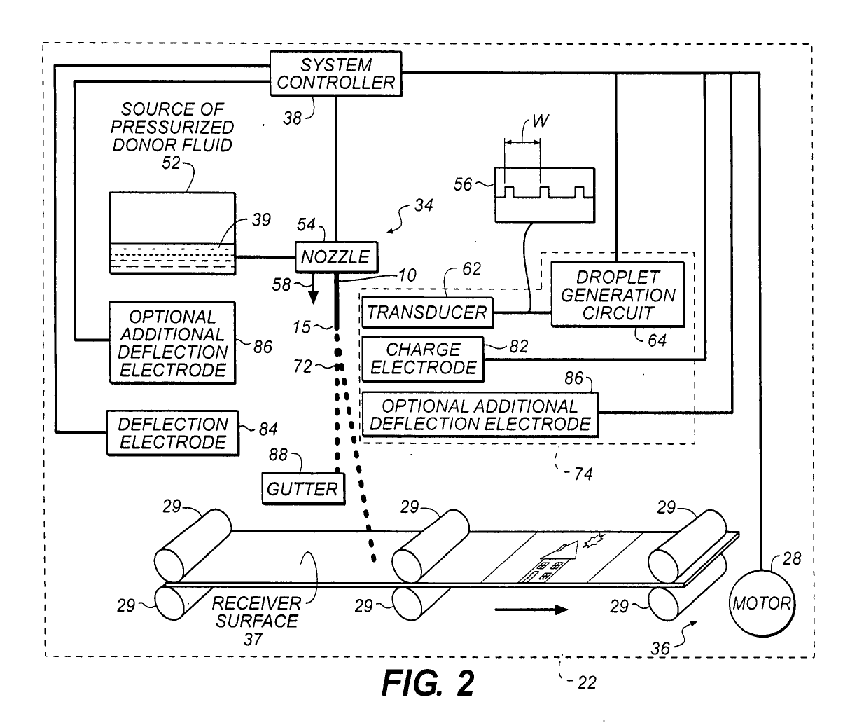

Undesired charge electrode-to-droplet interaction problems are illustrated in a prior art charge electrode schematically represented in FIG. 1A. In the prior art system illustrated in FIGS. 1A-1C, a prior art potential signal 12 is applied to a prior art charge electrode 92 to selectively induce a charge in various drops in the stream of droplets. Prior art charge electrode 92 is long enough to have significant influence on print selectable droplet 40 during the act of applying the appropriate charge state of separating print selectable droplet 20. In the prior art system shown in FIG. 1A, non-print selectable droplets 30 and print selectable droplets 20 selected not to be print selected droplets are charged with a substantially neutral polarity, while print selectable droplets selected to be print selectable droplets 40, 41, 42, 43, and 44 are charged with a substantially negative polarity. As shown in FIG. 1A, print selectable droplet 40 was selected to be a print selected droplet and consequently has a negative polarity. While it may be advantageous to have a long charge electrode to maximize droplet charges by increasing capacitive coupling at the point of the droplet break-off, additional unnecessary electrode length will have detrimental effects. Portions of a long charge electrode that extend significantly upstream from a jet break-off point may increase electrode-to-jet capacitance and increase an RC time constant for the charging. Increased RC time constants may lead to a slower charging rate and reduced droplet charges. A charge electrode length beyond the length of about 3 to 4 d (d being as previously defined) to either side of the break-off point 15 will typically have no further effect on coupling but may adversely affect previously charged print selected droplets. While such a long charge electrode may not change the magnitude or polarity of a charge on the previously emitted print selectable droplet 40, print selectable droplet 40 may still be deflected from its intended trajectory.

Any such deflection will depend upon the potential of prior art charge electrode 92 during the charging cycle for print selectable droplet 20. If print selectable droplet 20 is selected to be a print selected droplet by the print data stream, prior art charge electrode 92 will apply a positive potential to induce a negative charge upon print selectable droplet 20. This positive potential may cause the undesired deflection of print selectable droplet 40 that is still traveling within the bounds of prior art charge electrode 92. Therefore in this example, the data-dependence charging of the print selectable droplet 20 may cause undesired data-dependent deflection of the previously emitted print selectable droplet 40. It should be noted that in FIG. 1A, print selectable droplets 40, 41, 42, 43, and 44 were selected be print selected droplets and consequently are negatively charged. The deflection of print selectable droplets 40, 41, 42, 43 and 44 illustrated in FIG. 1A, is due to the undesired electric field effects created by the substantially long length of prior art charge electrode 92 during the data dependant charging of print selectable droplets formed at break-off point 15. An electrostatic deflection electrode (not shown) would further deflect these print selected droplets onto a recording surface, but with the same data dependant pointing errors.

The data-dependent deflection of print selected droplets is further illustrated in a prior art charge electrode shown in FIG IC. In this prior art charge electrode arrangement print selectable droplets 20, 40-44, 46 and 47 are all selected to be print selected droplets and are charged negative. As previously described, print selectable droplet 40 may be deflected from its intended trajectory by electrostatic field effects created by the charging of successively formed print selectable droplet 20. Prior to the formation and emission of print selectable droplets 20 and 40, print selectable droplet 45 was selected not to be a print selected droplet and was charged neutral. In contrast, print selectable droplet 46 was emitted successively before print selectable droplet 45 but was selected to be a print selected droplet and was charged negative. The trajectory of print selectable droplet 46 was not significantly altered because the subsequently formed print selectable droplet 45 was not charged negatively to create the undesired charge electrode electrostatic field effects. Therefore a trajectory of a given print selected droplet in the sequence of droplets may vary in accordance with a print data dependant charging of a print selectable droplet that is successively formed and charged after the given print selected droplet.

In another prior art system shown in FIG. 1B, print selectable droplets selected to be print selected droplets are held at substantially neutral charge while print selectable droplets selected not be print selected droplets are charged with a negative polarity. Non-print selectable droplets 30 are charged with a negative polarity. Undesired data dependent deflection of a substantially neutral print selected droplet may also occur due to the effect of a data-dependent field produced by prior art charge electrode 92 on a succeeding print selectable droplet. As shown in FIG. 1B, print selectable droplet 40 has been selected to be a print selected droplet, and is neutral. Since print selectable droplet 20 is selected not to be a print selected droplet, droplet 20 is charged with a required negative polarity. The field produced by prior art charge electrode 92 during the charging of droplet 20 will create a separation of charge on the conductive fluid of the preceding neutrally charged print selectable droplet 40. A resulting dipole on the neutral print selected droplet will interact with the electrode field to produce an electrostatic force on print selectable droplet 40. The electrostatic force may cause a deflection of the neutral print selectable droplet 40 from its intended trajectory. This undesired trajectory deflection is data dependent because the length of prior art charge electrode 92 is such that the field from the charge electrode affects previously emitted print selected droplets.

Again referring to FIG. 1B, it should be noted that neutrally charged print selectable droplet 40 is also influenced by prior art charge electrode 92 during the charging of non-print selectable droplets 30. This influence is constant as the neutrally charged print selectable droplet 40 and all preceding and subsequent print selected droplets are uniformly influenced by the same exposure to the identical charging potential sequence of the non-print selectable droplets 30. The trajectory of print selected droplets may be compensated to account for the uniform field effects created from the charging of non-print selectable droplets. The data-dependent deflection of a given print selected droplet caused by the data-dependent charging of a successive print selectable droplet may not be easily compensated. The deflections of print selectable droplets 40, 41, 42, 43 and 44 shown in FIG. 1B have been exaggerated for the purposes of clarity. Deflections of neutral print selectable droplets arising from dipole forces as shown in FIG. 1B are typically smaller than the deflections of negatively charged print selectable droplets shown in FIG. 1A. It should be further noted that groups of non-print selectable droplets 30 illustrated in FIG. 1B are shown as not being deflected for the purposes of clarity only. In the case shown in FIG. 1B, the groups of negatively charged non-print selectable droplets 30 and print selectable droplets that are charged negatively when selected not to be print selected droplets will typically be deflected in a data dependant manner by the charge electrode. The magnitudes of the deflections of the negatively charged droplets are typically greater than the deflections of the neutral droplets in the stream. However, since these negatively charged droplets are guttered, print quality is not affected.

Another problem may be associated with long prior art charge electrode 92 of the prior art system shown in FIG. 1A. Upstream of the break-off point 15, conductive fluid jet 10 may be attracted to prior art charge electrode 92 when a required charge potential is applied to prior art charge electrode 92. Continuous inkjet systems are typically based on the physics of an unconstrained fluid jet, famously analyzed by Lord Rayleigh in 1878. According to Lord Rayleigh, a perturbed fluid jet will form a continuous stream of droplets with a droplet-to-droplet spacing equal to a distance S. The volume of each of the stream of droplets 72 will be substantially equal to a volume of a portion of fluid jet 10. This portion of fluid jet 10 will be substantially one S length long. Therefore each successive formation of the non-print selectable droplets 30 and the print selectable droplets 20 will be formed from a corresponding successive portion of fluid jet 10 that is one S long. As shown in FIG. 1A, the next print selectable droplet formed after print selectable droplet 20 will be formed from portion 50 of fluid jet 10 which is four S upstream from break-off point 15. Portion 50 may be attracted towards prior art charge electrode 92 during the data dependant charging of print selectable droplet 20. Data dependant attraction of portion 50 may cause an undesired deflection of fluid jet 10 that results in data dependant jet pointing errors as droplets break-off from fluid jet 10. Referring to FIG. 1A, portion 50 will be attracted to prior art charge electrode 92 if print selectable droplet 20 is charged negative to produce a print selected droplet. Referring to FIG. 1B, portion 50 will be attracted to the prior art charge electrode 92 if print selectable droplet 20 is charged negative to not produce a print selected droplet. Again referring to FIG. 1B, the charging of non-print selectable droplets may also cause a deflection of fluid jet 10 but since the number of non-print selectable droplets 30 between print selectable droplets 20 is fixed, the deflection is constant and not data dependent and may be compensated for. In both cases shown in FIG. 1A and FIG. 1B, the attraction of portion 50 to the charge electrode will vary in data dependant manner that may adversely impact print drop placement accuracy.

Referring back to the preferred embodiment of the present invention shown in FIGS. 3A-3E, a solution to the problems created by the prior art charge electrodes 92 is established by ensuring that charge electrode 82 has a charging surface 90 that has an appropriately sized “charging length”. Charging surface 90 is a part of the charge electrode structure which is electrically conductive and whose potential varies according to the potential waveform of the charge electrode potential signal 56. Charging surface 90 is sized and positioned such that charge electrode 82 does not adversely influence the trajectory of a previously emitted print selected droplet during the data dependant charging of a succeeding print selectable droplet. Further, charging surface 90 is also sized and positioned such that an attractive force on an upstream region of fluid jet 10 from which a next print selectable droplet is formed, is substantially constant throughout a charging sequence to minimize data dependant jet pointing errors. Charging surface 90 is preferably sized such that the “charging length” is shorter than twice the center-to-center distance S between two consecutive print selectable droplets. In the preferred embodiment of the present invention shown in the sequence of FIGS. 3A-3E, a 1:4 guard drop scheme is employed. When a 1:4 guard drop scheme is employed, three non-print selectable droplets are used to separate any two consecutive print selectable droplets, and charging surface 90 may be sized to have a charging length approximately equal to 7S, wherein S is the center-to-center distance between successively formed droplets in the continuous stream of droplets. The term “charging length” of a charge electrode is herein used to describe a length of prior art charging surface 90 of charge electrode 82.

Charge electrode 82 is preferably positioned such that a mid point of charging surface 90 is substantially adjacent to a droplet formed at the break-off point 15. As shown in FIG. 3A, previously emitted print selectable droplet 40 (charged to be a print selected droplet) is clear of the most significant influence of charge electrode 82 before the potential state of the next print datum charges the next print selectable droplet 20. Any attractive force exerted by charge electrode 82 on fluid jet 10 is typically applied substantially only to a part of fluid jet 10 that is downstream from portion 50. Portion 50 of fluidjet 10 typically forms the following print selectable droplet. As shown in the sequence of FIG. 3A-3E, print selectable droplet 20 (charged as a print selected droplet) travels downstream during the charging of non-print selectable droplets 31, 32, and 33. Print selectable droplet 20 is substantially free of the electrostatic field interactions when charge electrode 82 charges the next print selectable droplet 18. Print selectable droplet 18 is formed from portion 50 of fluid jet 10, which travels through positions indicated by portions 18′, 18″, and 18′″ during the formation of non-print selectable droplets 31, 32 and 33 and is substantially free of data dependant charging effects.

By employing a charging surface 90 with an appropriately sized charging length, charge electrodes as per embodiments of the present invention typically significantly reduce undesired field effects on a previously emitted print selected droplet during the charging of a successive print selectable droplet, as well as provide a uniform and consistent attractive force on portion 50 of the fluid jet from which the successive print selectable drop will be formed. Other preferred embodiments of the present invention are not limited to the 1:4 guard drop scheme illustrated in FIGS. 3A-3E. In a general case, it is possible to implement a 1-in-X or 1:X guard drop scheme, where X is an integer greater than 1 and is equal to N+1 where N is equal to the integer number of non-print selectable droplets 30 chosen to separate two successive print selectable droplets from each other. Hence, alternate guard drop schemes may include, but are not limited to 1:2 or 1:3 guard schemes. Since the number of non-print selectable droplets separating two successive print selectable droplets from each will vary in accordance with the specific 1:X guard drop scheme employed, a charging length of the electrode charging surface may be defined by the following relationship:
L_{CE}≦(2N+1)S, (1)

wherein:

L_{CE} is a charging length of the charging surface,

N is an integer number of non-print selectable droplets separating two successive print selectable droplets from each other, wherein integer number N is equal to one or greater, and

S is a center-to-center distance between successively formed droplets within the stream of droplets.

In a preferred embodiment of the present invention, a length of a first portion of the charge electrode's charging surface that extends downstream from a droplet formed at the break-off point may be defined by the following relationship:
L_{CEB}≦[(2N+1)2]S, (2)

wherein:

L_{CEB} is a length of a first portion of the charge electrode that may extend downstream from a droplet formed at the break-off point,

N is an integer number of non-print selectable droplets separating two successive print selectable droplets from each other, wherein integer number N is equal to one or greater, and

S is a center-to-center distance between successively formed droplets in the continuous stream of droplets.

As shown in FIG. 3A, L_{CEB′} is a length of a second portion of charge electrode 82 that may extend upstream from a droplet formed at break-off point 15 thereby positioning charge electrode 82 so as to provide a uniform and constant attractive force on portion 50 of fluid jet 10, thus reducing print data dependant jet pointing errors. In a preferred embodiment of the present invention, a length of a second portion of the charge electrode's charging surface that extends upstream from a droplet formed at the break-off point may be defined by the following relationship:
L_{CEB′}≦[(2N+1)/2]S, (3)

wherein:

L_{CEB′} is a length of a second portion of the charge electrode that may extend upstream from a droplet formed at the break-off point,

N is an integer number of non-print selectable droplets separating 30 two successive print selectable droplets from each other, wherein integer number N is equal to one or greater, and

S is a center-to-center distance between successively formed droplets in the continuous stream of droplets.

As shown in FIG. 3A, a charging length and positioning of charge electrode 82 is chosen such the end of charging surface 100A is approximately adjacent to a midpoint between non-print selectable droplet 30′ and print selectable droplet 40 (charged as a print selected droplet). With this charging length and positioning of charge electrode 82, the group of non-print selectable droplets 30 (comprising droplets 30′, 30″ and 30′″), typically all see the same influence from charge electrode 82 during the charging of print selectable droplet 20, yet print selectable droplet 40 is clear of the charge electrode by distance approximately equal to S/2. It should be noted that under these conditions, the trajectory of the non-print selectable droplets 30′, 30″ and 30′″ will likely be affected by the field effects of the charge electrode 82 as it charges print selectable droplet 20. In this regard, the subsequent landing position of the non-print selectable droplets 30′, 30″ and 30′″ on a gutter 88 will typically be affected in a data dependant manner. However, printing quality is not affected since the trajectory of print selectable droplet 40 (which is charged as a print selected droplet) is not substantially affected by these data dependant field effects. There exists a range of charge electrode charge length and position combinations wherein the data dependant field effects on print selectable droplet 40 do not significantly adversely affect print quality. As a limit of the range, the position and charging length of charge electrode 82 may be varied such that the end of the charge electrode is preferably in a range of ±S/2 from a point adjacent to a midpoint between the non-print selectable droplet 30′ and the print selectable droplet 40. Relationships (1), (2) and (3) may be adjusted as follows:
Preferable L_{CE}≦[(2N+1)]S+S, or its equivalent: L_{CE}≦2 S(N+1); (4)
Preferable L_{CEB}≦[(2N+1)/2]S+S/2, or its equivalent: L_{CEB}≦S(N+1); (5)
Preferable L_{CEB′}≦[(2N+1)/2]S+S/2, or its equivalent: L_{CEB′}≦S(N+1); (6)

wherein variables: L_{CE}, L_{CEB}, L_{CEB′}, N and S are as previously defined.

It is to be noted that benefits of the present invention may be achieved with shorter charging lengths and positions as established stated in relationships (1), (2), (3), (4), (5) and (6). However, significant shortening of the charge electrode may result in other complications including a reduction in the charging efficiency due to reduced coupling of the charge electrode at the break-off point.

In some preferred embodiments of the present invention, it is to be understood that the charge electrode 82 may be positioned such that its' charging surface 90 is substantially aligned with the trajectory of the fluid jet and the stream of droplets that are formed from that jet prior to any subsequent deflection of any of these droplets. In other preferred embodiments of the invention, the charge electrode may be positioned such that it's charging length is aligned with respect to the trajectory of the un-deflected stream of droplets. In yet other embodiments of the present invention, a length L_{CEB} of a first portion of the charge electrode that extends downstream from a droplet formed at the break-off point may be equal to a length L_{CEB′} of a second portion of the charge electrode that extends upstream from the droplet formed at the break-off point. In this context, the terms “downstream” and “upstream” are referenced with the direction of travel of fluid jet 10.

Other preferred embodiments of the present invention may include forming and charging a continuous stream of fluid droplets in accordance with a charging length L_{CE} of a given charge electrode that is used to selectively charge droplets within the continuous stream of fluid droplets. The formation of the continuous stream of droplets may be adjusted in accordance with a charging length L_{CE} of a given charge electrode to minimize trajectory variations of a previously emitted print selected droplet during the data dependant charging of a successively formed print selectable droplet. The formation of the continuous stream of fluid droplets may be adjusted in accordance with a charging length L_{CE} of a given charge electrode to minimizing data dependant jet pointing errors during the selective charging of a plurality of print selectable droplets within the continuous stream.

In one embodiment of the present invention, a distance S between successively formed droplets within the continuous stream of droplets 72 may be adjusted in accordance with the charging length L_{CE} of a given charge electrode 82. Other preferred embodiments of the present invention may include selecting and forming two successive print selectable droplets within a continuous stream of fluid droplets in which two successive print selectable droplets are separated from each other by an integer number N of non-print selectable droplets. The integer number N is one or greater and may be determined from a charging length L_{CE} of a given charge electrode used to selectively charge droplets within the continuous stream of droplets 72. In other embodiments of the present invention, distance S and/or integer number N may be chosen in accordance with a desired 1:X guard drop scheme that one may wish to employ. In yet other embodiments of the present invention, distance S and/or integer number N may be chosen to satisfy a relationship: L_{CE}<2S(N+1), where L_{CE} is the charging length of a given charge electrode 82.

The preferred embodiment of the invention illustrated in FIGS. 3A-3E discloses a single nozzle. Other preferred embodiments of the invention may include a group or row of multiple nozzles. Other preferred embodiments of the invention may also include multi-jet or multi-rows of nozzles. In these preferred embodiments of the invention, different nozzles, or groups of nozzles, or rows of nozzles may include different charging schemes.

The invention has been described in detail with particular reference to certain preferred embodiments thereof, but it will be understood that variations and modifications can be effected within the spirit and scope of the invention.

### PARTS LIST

10 fluid jet
12 prior art charging signal
14 apparatus
15 break-off point
18 print selectable droplets
18′ portion
18″ portion
18′″ portion
20 print selectable droplets
22 printing apparatus
24 housing
26 interior chamber
28 motor
29 roller
30 non-print selectable droplet
30′ non-print selectable droplet
30″ non-print selectable droplet
30′″ non-print selectable droplet
34 inkjet printhead
36 translation unit
37 receiver surface
38 system controller
39 donor fluid
40 print selectable droplet
41 print selectable droplet
42 print selectable droplet
43 print selectable droplet
44 print selectable droplet
45 non-selected print selectable droplet
46 print selectable droplet
47 print selectable droplet
50 portion of fluid jet
52 source of pressurized donor fluid
54 nozzle
56 charge electrode potential signal
58 first direction
62 transducer
64 droplet generation circuit
66 droplet formation electrical signal
72 stream of droplets
82 charge electrode
83 optional additional charge electrode
84 deflection electrode
86 optional additional deflection electrode
88 gutter
90 charging surface
92 prior art charge electrode
d distance from center line to charging surface
S drop center-to-center separation distance
W wavelength
CL center line of fluid jet

1. A method for forming and charging fluid droplets, the method comprising the steps of:
forming a stream of fluid droplets with at least two successively formed fluid droplets within the continuous stream separated from each other by a separation distance S, and using a charging electrode having a charging length L_{CE} to deliver an electrical charge to the fluid droplets, wherein the separation distance S is proportional to charging length L_{CE}.

2. The method of claim 1, wherein the step forming two successive print selectable droplets within the stream further comprises separating the two successive print selectable droplets from each other by an integer number N of non-print selectable droplets, wherein the integer number N is at least one and is proportional to the charging length L_{CE}.

3. The method of claim 1, wherein the distance S is determined in accordance with a 1:X guard drop scheme.

4. The method of claim 2, wherein the integer number N is determined in accordance with a 1:X guard drop scheme.

5. The method of claim 2, wherein the distance S and the integer number N are determined to satisfy a relationship: L_{CE}≦2S(N+1).

6. The method of claim 1, wherein the stream of fluid droplets is formed at a break-off point of a fluid jet, and positioning the charge electrode such that a first portion of the charge electrode extends in a direction downstream from a fluid droplet formed at the break-off point.

7. The method of claim 6, wherein a length L_{CEB} of the first portion of the charge electrode satisfies a relationship: L_{CEB}≦S(N+1).

8. The method of claim 6, wherein a length L_{CEB} of the first portion of the charge electrode is substantially one half of the charging length L_{CE}.

9. The method of claim 2, comprising positioning the charge electrode such that a substantially uniform and constant force is exerted on a portion of the fluid jet during a charging of a print selectable droplet formed at the break-off point.

10. The method of claim 1, comprising positioning the charge electrode such that a second portion of the charge electrode extends in a direction upstream from a droplet formed at a break-off point.

11. The method of claim 10, wherein a length L_{CEB′} of the second portion of the charge electrode satisfies a relationship: L_{CEB′}≦S(N+1).

12. The method of claim 10, wherein a length L_{CEB′} of the second portion of the charge electrode is determined to be equal to a length L_{CEB} of a first portion of the charge electrode.

13. An apparatus for modifying a fluid jet, the apparatus comprising:
a droplet generation circuit having an electrically controlled transducer adapted to perturb the jet of fluid to form a stream of droplets;
a charge electrode having a length L_{CE}, said charge electrode being capable of delivering an electrical field to charge selected droplets when potential is applied to the charge electrode;
wherein said droplet generation circuit perturbs the jet of fluid in a manner that causes the jet of fluid to form a stream of successive droplets each droplet being separated by a distance S that is proportional to the length L_{CE} of the charge electrode.

14. The apparatus of claim 13, wherein the droplet generation circuit is further adapted to form said stream of droplets with successive print selectable droplets separated by at least one non-print selectable droplet and wherein the length L_{CE} is further proportional to the number N of non-print selectable droplets between successive print selectable droplets.

15. The apparatus of claim 14, further comprising a system controller that is operable to cause a pattern of electrical potential to be applied to the charge electrode in a manner that causes a charge to be delivered to selected ones of the stream of droplets in accordance with a print data stream.

16. The apparatus of claim 14, further comprising a system controller that is operable for causing a charge to be delivered to at least one of the two successive print selectable droplets and the non-print selectable droplets in accordance with a 1:X guard drop scheme.

17. The apparatus of claim 14, wherein any of the charging length L_{CE}, the distance S and the number N are determined to satisfy a relationship: L_{CE}≦2S(N+1).

18. The apparatus of claim 14, wherein the droplet generation circuit is operable for forming the stream of fluid droplets at a break-off point, and wherein a first portion of the charge electrode extends downstream from a droplet formed at the break-off point.

19. The apparatus of claim 18, wherein a length L_{CEB} of the first portion of the charge electrode satisfies a relationship: L_{CEB}≦S(N+1).

20. The apparatus of claim 18, wherein a length L_{CEB} of the first portion of the charge electrode is substantially one-half of the length of the charge electrode.

21. The apparatus of claim 18, wherein the droplet generation circuit is operable for forming the stream of droplets at a break-off point, and wherein a second portion of the charge electrode extends in a direction upstream from a droplet formed at the break-off point.

22. The apparatus of claim 21 wherein a length L_{CEB′} of the second portion of the charge electrode satisfies a relationship: L_{CEB′}≦S(N+1).

23. The apparatus of claim 14, further comprising at least one electrostatic deflection electrode positioned and down stream of the charge electrode and adapted to receive an electrical deflection signal and to generate and electrostatic field for altering trajectory of at least one of a non-print selectable droplet, a print selectable droplet selected not to be a print selected droplet, and a print selectable droplet selected to be a print selected droplet.

24. The apparatus of claim 23, wherein the apparatus is adapted for use in a continuous inkjet printing apparatus or a multi-jet continuous inkjet printing apparatus.
